(19) United States
(12) Patent Application Publication
(10) Pub. No.: US 2020/0284509 A1
(43) Pub. Date: Sep. 10, 2020

(54) PAINT CURING SYSTEMS AND METHODS

(71) Applicant: US Auto Cure, LLC, Tempe, AZ (US)

(72) Inventor: Michael F. Meyer, JR., Phoenix, AZ (US)

(73) Assignee: US Auto Cure, LLC, Tempe, AZ (US)

(21) Appl. No.: 16/293,497

(22) Filed: Mar. 5, 2019

(51) Int. Cl. F26B 3/30

(52) U.S. Cl. CPC F26B 3/30

(57) ABSTRACT

A curing system can include a movable housing, a curtain, one or more shutters, and a control unit. The curtain can comprise at least one curing element and can be coupled to the housing and movable relative to the housing. The one or more shutters can each comprise one or more curing elements, the curing elements being movable relative to the shutters. The control unit can be configured to operate the curing system based on one or more system inputs including a recipe, a template, and one or more system parameters.

### FIELD

The present disclosure relates to systems and method for curing paint.

### BACKGROUND

Typically, vehicles are painted within a specialized paint booth, to allow for proper enclosure and ventilation during the painting process, which can involve flammable and potentially hazardous chemicals. Once applied, the paint is typically cured to prevent stickiness, tackiness, and/or foreign object damage. In some industries, such as the auto industry, specially formulated paint recipes can be used in combination with Ultra-violet (UV) and Infrared (IR) light exposure to accelerate paint curing time and improve surface finish quality. However, such light exposure can be time consuming and require continuous operator supervision to position the light sources and move them once curing has been completed.

Accordingly, a need exists to address these and other issues associated with curing processes.

### SUMMARY

Described herein are embodiments of improved automated curing systems, as well as methods for using such systems.

In a representative embodiment, a curing system can comprise a movable housing having a first side portion and a second side portion, one or more curing elements coupled to the movable housing an movable relative to the movable housing, and a control unit. The control unit can be configured to adjust a speed of the movable housing and a temperature generated by the one or more curing elements such that a surface of an object to be cured reaches a selected temperature for a selected time period. The control unit can be operatively connected to one or more sensors configured to measure a distance of a respective curing element from the surface of the object.

In some embodiments, the movable housing can comprise a first shutter and a second shutter movable relative to the movable housing. Each shutter can be coupled to at least one of the one or more curing elements and wherein the one or more curing elements are pivotable relative to the first and second shutters.

In some embodiments, the movable housing can comprise comprises a curtain coupled to and extending between the first and second side portions. The curtain can be movable along a first axis and rotatable about a second axis relative to the first and second side portions, and can be coupled to at least one of the curing elements.

In some embodiments, the control unit can be operatively connected to one or more sensors configured to measure a temperature of a surface of the object. In some embodiments, the control unit is configured to scan the object and position the one or more curing elements at a selected angle and distance relative to the object. In some embodiments, the control unit is configured to receive and store recipe data, the recipe data comprising the selected temperature. In some embodiments, the control unit is configured to receive and store template data, the template data comprising a template of the object to be cured. In some embodiments, the control unit is configured to position the one or more curing elements based on the template data.

In some embodiments, the one or more curing elements comprise at least one of infrared (IR) elements and ultraviolet (UV) elements.

In some embodiments, the curing system further comprises one or more tracks to which the movable housing is movably coupled.

In some embodiments, the curing system is configured to operate within a painting booth.

In a representative embodiment, a curing system comprises a movable housing having a first side portion and a second side portion, a curtain, one or more shutters, and a control unit. The curtain can comprise one or more curing elements and can be coupled to and extend between the first and second side portions. The curtain can be movable relative to the housing along a first axis and rotatable relative to the housing about a second axis. The one or more shutters can each comprise one or more curing elements pivotably coupled to the shutters. The shutters can be coupled to the housing and movable relative to the housing along a third axis. The control unit can be configured to receive and store one or more system inputs and to operate the curing system in an automated mode. When in the automated mode the control unit can automatically adjust at least one of a speed of the movable housing and a temperature generated by the one or more curing elements based on the one or more system inputs.

In some embodiments, the one or more system inputs include a recipe comprising a selected temperature. In some embodiments, the control unit automatically adjusts at least one of the speed of the movable housing and the temperature generated by the one or more curing elements such that a surface of an object to be cured reaches the selected temperature for a selected time period.

In some embodiments, the one or more system inputs comprise at least one of a surface temperature of the object to be cured, a position of the one or more curing elements relative to a surface of the object to be cured, and a speed of the curing system.

In some embodiments, the one or more system inputs include a template of the object to be cured. In some embodiments, the control unit is configured to position the one or more curing elements based on the template.

In a representative embodiment, a curing system can comprise a movable housing, a curtain coupled to the movable housing and being movable relative to the housing along a first axis and rotatable relative to the housing about a second axis, one or more shutters coupled to the movable housing and being movable relative to the housing along a third axis, and a control unit. The curtain can comprise one or more curing elements. The one or more shutters can each comprise one or more curing elements pivotably coupled to the shutters. The control unit can be configured to (a) receive and store recipe information, the recipe information comprising a selected temperature, (b) receive and store one or more system parameters, the one or more system parameters comprising: a surface temperature of an object to be cured, a position of the one or more curing elements relative to a surface of the object to be cured, and a speed of the movable housing, (c) receive and store template data comprising a template of the object to be cured, and (d) adjust at least one of: the speed of the movable housing, the temperature generated by the one or more curing elements, the position of the curing elements relative to the surface of the object to be cured based on the recipe, the one or more system parameters, and the template data.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of an exemplary curing system.

FIG. 2A is a perspective view of the curing system of FIG. 1 with the curing elements in a retracted position.

FIG. 2B is a perspective view of the curing system of FIG. 1 with the curing elements in a retracted position.

FIG. 2C is an enlarged perspective view of the sensor of FIG. 2B.

FIG. 3 is a perspective view of the curing system of FIG. 1 including an object to be cured.

FIG. 4 is a representative diagram of an exemplary computing environment.

FIG. 5 is an embodiment of a graphical user interface that includes a display area for displaying a template.

FIG. 6 is an embodiment of a graphical user interface that includes a display area for displaying the results of a scan.

FIG. 7 is an embodiment of a graphical user interface that includes a display area for displaying an alarm/alert list.

FIG. 8 is an embodiment of a graphical user interface that includes a display area for displaying current process parameters.

FIG. 9 is an embodiment of a graphical user interface that includes a display area for displaying a zoned template.

### DETAILED DESCRIPTION

### Exemplary Embodiments

Described herein are embodiments of automated curing systems comprising curing elements that are configured to be positioned at a selected distance adjacent the surface of an object to be cured such as, for example, an automobile and/or one or more components thereof. An automobile can include a car, truck, van, sport utility vehicle (SUV), and/or one or more components thereof. The systems can be used to cure paint that has been applied to the surface of the object. The term “paint” as used herein includes paint (including base coats), primer, varnish, lacquer, clearcoats, etc. In other embodiments, the object to be cured can be a fiberglass object. In still other embodiments, the curing device can be used to cure, for example, food, tobacco, cannabis, etc.

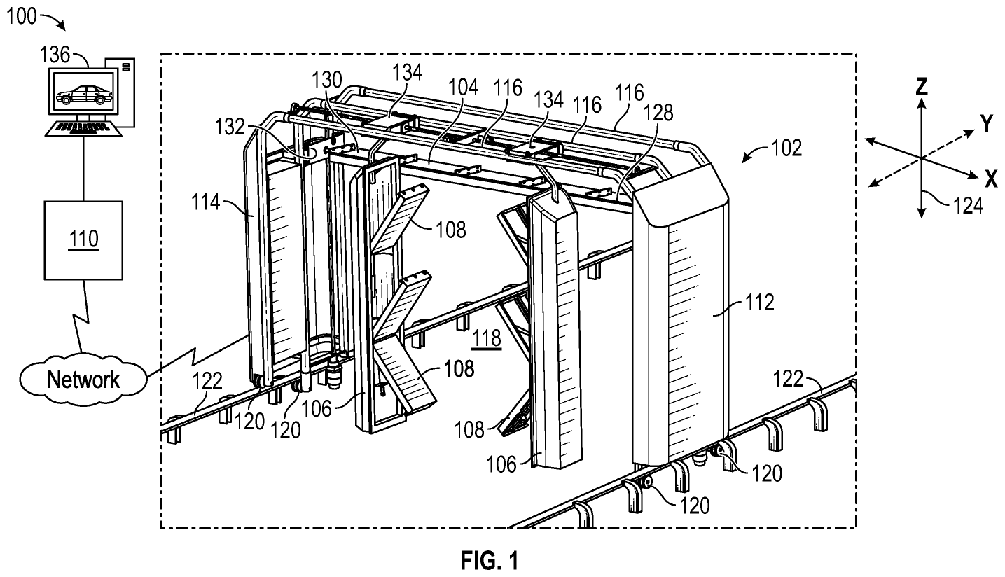

FIGS. 1-3 illustrate a representative embodiment of a curing system 100 comprising a housing 102 coupled to a curtain 104 and one or more shutters 106, the shutters and the curtain each comprising one or more heating elements 108. A control unit 110, discussed in more detail below, can be configured to control the operation of the curing system 100. The components of the curing system 100 are movable relative to one another such that a variety of object shapes can be accommodated. As an object is cured, the curing system 100 can pass over the surface of the object, maintaining a preselected distance, in order to cure the surface.

In some embodiments, the curing system 100 can be housed within a painting booth. In some embodiments, the painting booth can be a National Fire Protection Association (NFPA) compliant painting booth for use in painting automobiles. Generally, a NFPA compliant painting booth can have the following dimensions: a length of between about 25 feet to about 46 feet, a width of between about 12 feet to about 16 feet, and a height of between about 8 feet to about 12 feet tall. Typically, a painting booth is configured to have a first door at a first end portion and a second door at a second end portion, thereby allowing automobiles to drive, or otherwise move or be moved, through the painting booth along its length. The painting booth can further comprise one or more additional doors, such as doors leading to a control booth, etc. The booth can be configured to operate within an enclosed high volume interlocked ventilated atmosphere.

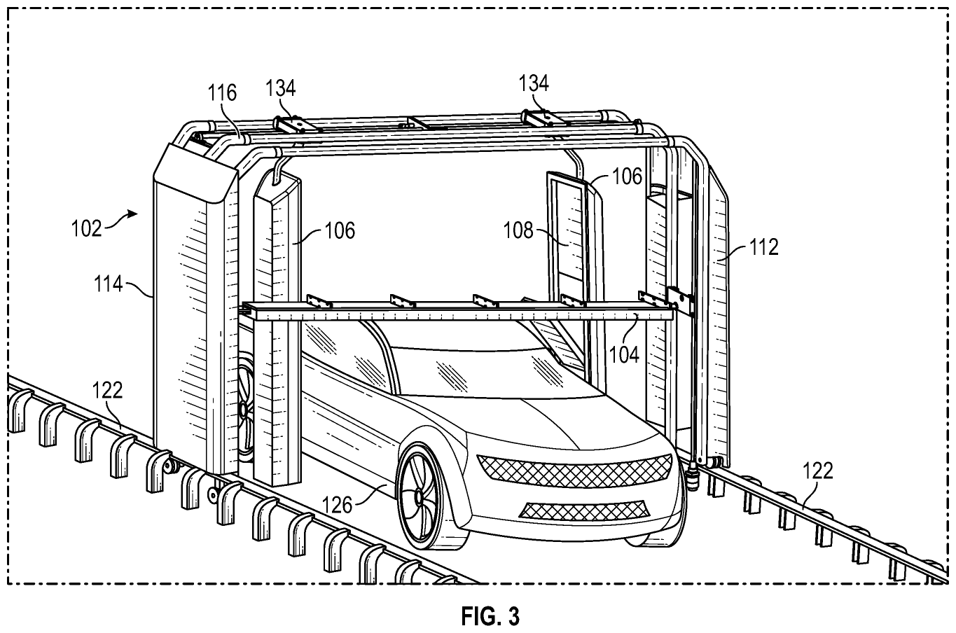

As mentioned above, the curing system 100 can comprise a housing 102. The housing 102 can comprise two or more side portions. For example, in the illustrated embodiment, the housing 102 comprises a first side portion 112 and a second side portion 114. The first and second side portions 112, 114 can be coupled together by rails 116 to define a curing space 118 between them. The side portions can be mounted on one or more wheels 120 configured to move the housing 102 axially along one or more tracks 122 extending parallel to a first axis Y, as shown with respect to a coordinate system 124. In some embodiments, the wheels 120 can be poly-V wheels and the tracks 122 can be gantry tracks. The wheels 120 can be operatively coupled to one or more motors (e.g., sealed brushless induction motors), configured to move the housing 102 along the tracks. During operation, the housing 102 can advance along the tracks 122 over the object to be cured (e.g., car 126 of FIG. 3), as described in more detail below.

The curing system 100 can further comprise one or more track sensors, such as proximity sensors, configured to monitor the motion of the housing 102 along the tracks 122. Each track 122 can have designated portions configured such that when the one or more track sensors pass a designated portion the housing will automatically enter a slow and park sequence.

In some embodiments, the housing 102, including the side portions 112, 114 and the rails 116 can comprise stainless steel. As mentioned above, the housing 102 can be coupled to a curtain 104. The curtain 104 can have a first end portion 128, a second end portion 130, and one or more curing elements (e.g., mounted on underside surface of the curtain 104), described in further detail below. The first and second end portions 128, 130 of the curtain 104 can be movably and rotatably coupled to the first and second side portions 112, 114 of the housing, respectively. One or more motors such as risers 132 can be coupled to the first and second ends 128, 130 of the curtain. The risers 132 can be configured to move (e.g., lift, lower, and rotate) the curtain 104 relative to the housing. In some embodiments, the risers can be, for example, servo-driven screw shafts. The risers can rotate the curtain 104 relative to the housing 102 about a second axis X extending along a length of the curtain and perpendicular to the first axis Y, and/or the risers can move the curtain 104 upward and downward relative to the housing 102 along a third axis Z extending perpendicularly to both the first axis Y and the second axis X. Such movements allow the curtain to follow and/or track the shape of an object situated in the curing space 118. In other words, the curtain 104 can move such that it maintains a predetermined distance from the surface of the object. In embodiments in which the object to be cured is an automobile, the curtain 104 can cure the front and rear bumpers of the automobile, along with the roof and hood panels as it passes over them.

As shown in FIG. 3, in operation, the vertical height of the curtain 104 (i.e., the position of the curtain along the Z-axis) can be adjusted according to the height of the object to be cured. In some embodiments, for example, the curtain 104 can raise as high as 14 feet, or as low as 7 inches. The curtain 104 can pivot relative to the X-axis approximately 180 degrees, such that opposing surfaces of the object (e.g., a front surface such as a front bumper and a rear surface such as a rear bumper) can be cured.

The rails 116 of the housing 102 can be coupled to one or more shutters 106. The shutters 106 can be controlled by one or more motors 134, for example, sealed brushless induction motors. The motors 134 can be configured to move the shutters relative to the housing 102 along the rails 116 in a direction parallel to the second axis X. Each shutter can move independently or in tandem with one or more of the other shutters. In the illustrated embodiment, the shutters are shown as flat panels having a rectangular cross-section. However, in other embodiments, the shutters can have any shape in cross-section including but not limited to triangular, circular, ovular, and/or square. In some embodiments, the shutters 106 can have a concave or curved shape.

Each shutter 106 can comprise one or more curing elements 108, respectively. The curing elements can be configured to heat the surface of an object to be cured. In the illustrated embodiment, each shutter 106 includes three curing elements 108, however, in other embodiments, each shutter 106 can include, for example, between one and ten curing elements, respectively.

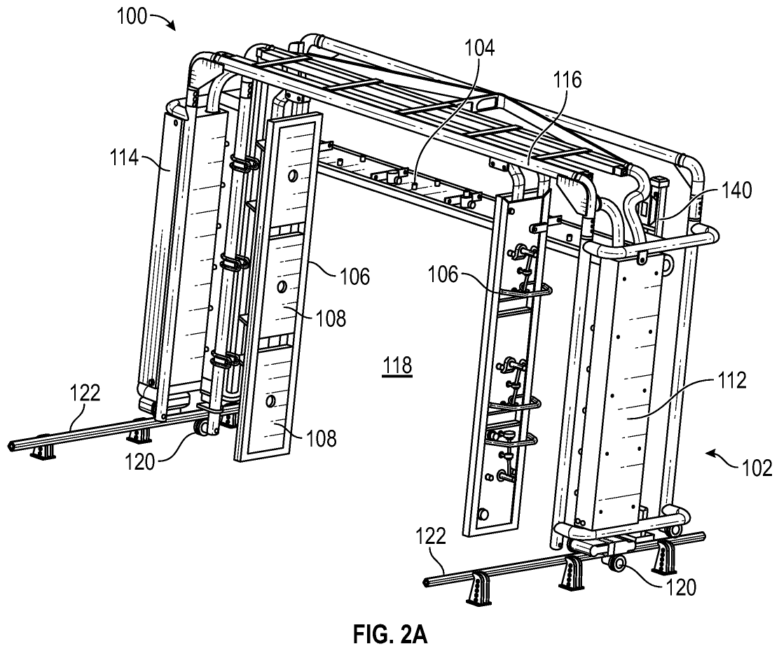

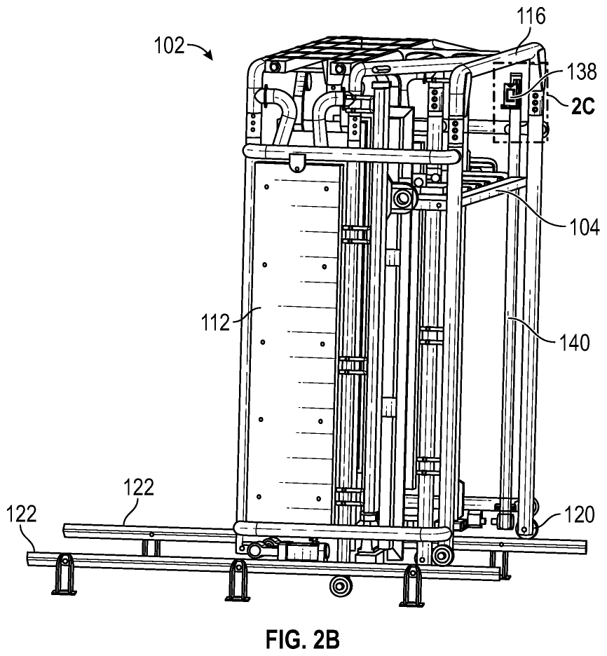

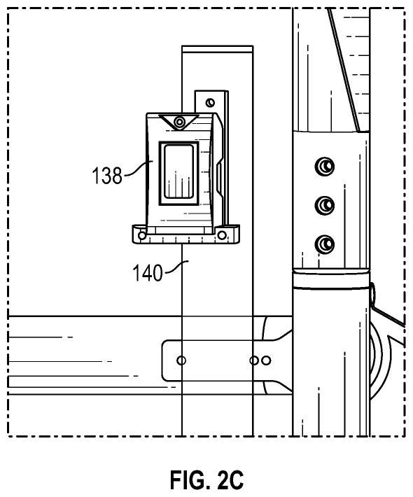

Each curing element 108 can be pivotably coupled to a respective shutter 106 such that it is movable in the ZX-plane relative to the shutter 106 between an extended position (see e.g., FIG. 1) and a retracted position (see e.g., FIG. 2). Each curing element can move independently or in tandem with one or more of the other curing elements. The pivoting movement of the curing elements 108 can be controlled by one or more motors (not shown). The motors can be sealed brushless induction motors such as, for example, Copley driven Stepper motors and screw shafts. The movement of the shutters 106 along the rails, as well as the pivoting movement of the curing elements 108, allows the curing elements 108 to “cup” the object to be cured and maintain a predetermined distance from the surface of the object. In embodiments in which the object to be cured is an automobile, the curing elements 108 can pivot to match the lower rocker angles and/or top edges of the roof lines.

The curing elements 108 can be heating elements such as, for example, ultra-violet (UV) and/or infrared (IR) heating elements. In some embodiments, the curing elements can comprise more than one type of heating element. In some particular embodiments, each curing element can be a 230 VAC heating element. In some embodiments, the curing elements can use natural gas and/or propane as fuel. In such embodiments, the natural gas and/or propane can be fluidly coupled to the curing elements 108 using flexible hoses, such as fast connect high grade compliant braided flexible hoses.

In the illustrated embodiment, the curing elements 108 are shown as panels having a rectangular cross-section. However, in other embodiments, the curing elements can have any shape in cross-section including but not limited to, triangular, circular, ovular, and/or square. In some embodiments, the curing elements 108 can have a concave or curved shape.

The curing system 100 can further comprise one or more sensors 138 (see e.g., FIGS. 2B-2C). As shown in FIG. 2B, the sensors 138 can be coupled to one or more forward rails 140. For example, in the illustrated embodiment, the curing device 100 comprises two sensors 138 each coupled to a respective forward rail 140. The forward rails 140 can be positioned parallel to the side portions 112, 114, respectively, of the housing 102. The sensors 138 can be configured to move in a direction parallel to the Z-axis relative to the forward rail 140. In use, the one or more sensors 138 can move along the front in a direction parallel to the Z-axis as the housing 102 moves along the tracks to determine an outline of the object, as described in more detail below.

The sensors can be configured to measure a surface temperature of the object to be cured and/or a distance from the surface of the object to be cured to one or more curing elements. In some embodiments, the sensors can be scanning laser distance and temperature sensors. In some particular embodiments, the sensors can be “time of flight” sensors configured to measure the distance between the sensor and the object to be cured based on the time difference between the emission of a signal from the sensor and the return of the signal to the sensor after being reflected by the object. The sensors can be configured to scan the object to be cured and to determine an outline of the object. The scanning function of the sensors can be used to mitigate collisions of the curing panels with the object to be cured.

In some embodiments, in lieu of or in addition to the sensors 138 the curing system 100 can comprise one or more 3D cameras and/or one or more Lidar sensors.

The control unit 110 of the curing system 100 can use the outline to position the curing elements 108 at an optimal or preferred distance from the surface of the object. The ability of the curing system to detect the location of the object to be cured mitigates the necessity of perfectly centering the object within the curing space 118. Furthermore, individual pieces, such as fenders, can be cured in any orientation, such as side by side or front to back.

In some embodiments, the curing system 100 can further comprise a “weather station” including one or more ambient sensors configured to monitor the ambient temperature and/or ambient humidity of the environment surrounding the curing system. The control unit 110 can receive input from the ambient sensors and can automatically adjust the speed and/or temperature of the curing system 100 to compensate for environmental variations. In some embodiments, the weather station can monitor the temperature and/or humidity of a painting booth containing the curing system 100.

The one or more ambient sensors can be located on one or more electrical panels of the housing. In some embodiments, the weather station can further include a gas detection sensor. The gas detection sensor can be configured to provide an alert and/or an alarm when the level of gas in the environment exceeds a preselected threshold.

Each component of the curing system (e.g., each curing element, each shutter, each motor, each sensor) can be individually actuatable. In other words, each component can move and function independently of the other components. The individually actuatable components allow the curing system to be used with a variety of sizes of object to be cured. The modular nature of the curing system allows for economical shipping and quick on-site assembly of the components. Furthermore, the modularity of the components allows for the system to be customizable to different object sizes, including those outside of the “typical” object size range. For example, the curing system can be configured to be used on automobiles with higher and/or wider surfaces, such as recreational vehicles (RVs).

The curing system 100 can further comprise one or more safety interlocks (not shown) for one or more components of the system. The safety interlocks can be configured to ensure the positioning of certain components and/or disable one or more components. For example, safety interlocks can ensure that the doors are closed during all painting and curing operations. Safety interlocks can further ensure that the curing system 100 is fully inoperable during a paint-spraying operation. In some embodiments, the safety interlocks can disable one or more components of the curing system if a predetermined safety hazard is detected. Exemplary safety hazards include but are not limited to: the presence of people within the painting booth, potentially volatile gas concentrations in the booth, and/or exceeding the high temperature limit. In some embodiments, the safety interlocks can further comprise an alarm (e.g., an audible, visible or tactile alarm). Additionally, the safety interlocks can be configured to disable one or more components of the system for a specified time period (i.e., a timeout), for example, to ensure that sufficient ventilation of volatile gases has taken place.

As mentioned above, the curing system 100 can comprises a control unit 110 for controlling the curing system. For example, the control unit 110 can be configured to control the positioning of the system components, the temperature generated by the system, the speed of the system, etc.

In some embodiments, the curing system 100 can further include a computing system 136, which includes a display. In some embodiments, the display can be located remotely from the curing system, such as within a control booth of a paint booth. In other embodiments, the display can be located on a hand-held or mobile device. The display can be configured to display a graphical user interface (GUI) comprising one or more data outputs (e.g., a selected recipe, a template, a temperature, a speed, an alarm/alert, etc.) from the curing system 100. In some embodiments, the display can be a touchscreen display/UI and is configured to accept user input(s). The display can have any configuration suitable to display one or more of: (1) system input information such as a selected recipe including a selected template and/or a selected paint type; (2) system output information such as temperature, speed, scan information, and/or height and positioning information for each component of the curing system; (3) instructions to a user; (4) alerts/alarms; or (5) any combination thereof. In some embodiments, the display can be configured such that a user can input data to the control unit 100 via the display of computing system 136, as discussed in more detail below.

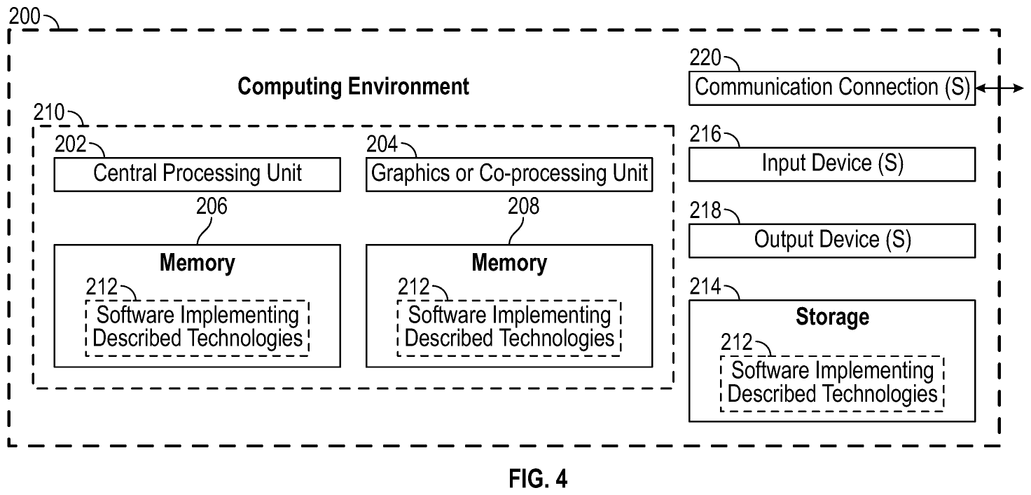

The following is a general description of a computing environment suitable for use with the disclosed control unit 110 and computing system 136. FIG. 4 depicts a generalized example of a suitable computing environment 200 in which software and control algorithms for the described innovations may be implemented. The computing environment 200 is not intended to suggest any limitation as to scope of use or functionality, as the innovations may be implemented in diverse general-purpose or special-purpose computing systems. For example, the computing environment 200 can be any of a variety of computing devices (e.g., desktop computer, laptop computer, server computer, tablet computer, gaming system, mobile device, programmable automation controller, etc.).

With reference to FIG. 4, the computing environment 200 includes one or more processing units 202, 204 and memory 206, 208 (e.g., for storing sequence data and/or system input data). In FIG. 4, this basic configuration 210 is included within a dashed line. The processing units 202, 204 execute computer executable instructions. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 4 shows a central processing unit 202 as well as a graphics processing unit 204. The tangible memory 206, 208 can be volatile memory (e.g., registers, cache, RAM), non-volatile memory (e.g., ROM, EEPROM, flash memory, etc.) or some combination of the two, accessible by the processing unit(s). The memory 206, 208 stores software 212 implementing one or more innovations described herein, in the form of computer-executable instructions suitable for execution by the processing unit(s).

A computing system may have additional features. For example, in some embodiments, the computing environment 200 includes storage 214, one or more input devices 216, one or more output devices 218, and one or more communication connections 220. An interconnection mechanism (not shown) such as a bus, controller, or network, interconnects the components of the computing environment 200. Typically, operating system software (not shown) provides an operating environment for other software executing in the computing environment 200, and coordinates activities of the components of the computing environment 200. In some embodiments, the computing system can include virtual network computing (VNC) functionality configured to allow operators to access the control unit 110 and computing environment 200 from a remote location. For example, the computing environment 200 can have remote dial-in capability. The VNC functionality can allow an operator to remotely access the computing environment in order to, for example, perform maintenance or live monitoring of the curing system, or to train an operator on the use of the curing system.

The tangible storage 214 may be removable or non-removable, and includes magnetic disks, magnetic tapes or cassettes, CD-ROMs, DVDs, or any other medium that can be used to store information in a non-transitory way and can be accessed within the computing environment 200. The storage 214 stores instructions for the software 212 implementing one or more innovations described herein (e.g., for storing sequence data, temperature data, template type data, location, date, etc.). In some embodiments, the storage can be a “cloud-based” system configured to store data, allow access to data, and/or generate reports. For example, data logs can be sent to a cloud system and reports can be generated therefrom. Users (including, for example, clients) can access the cloud system remotely through using selected log-in credentials.

The input device(s) 216 can be, for example: a touch input device, such as a touchscreen display, keyboard, mouse, pen, or trackball; a voice input device; a scanning device; any of various sensors (e.g., the quantity indicator, speed indicator, location unit, etc.); another device that provides input to the computing environment; or combinations thereof. The input device(s) can be remote from the control unit. The output device(s) 218 can be a display, printer, speaker, CD-writer, transmitter, or another device that provides output from the computing environment 200.

The communication connection(s) 220 enable communication over a communication medium to another computing entity. For example, the communication connection(s) can enable communication between the control unit 110 and a remote input device, for example, a phone app, or a computer browser. The communication medium conveys information, such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, Wi-Fi, or other carrier.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communications means include, for example, the Internet, an intranet, software applications, cable (including fiber optic cable), magnetic communications, electromagnetic communications (including RF, microwave, and infrared communications), electronic communications, or other such communication means.

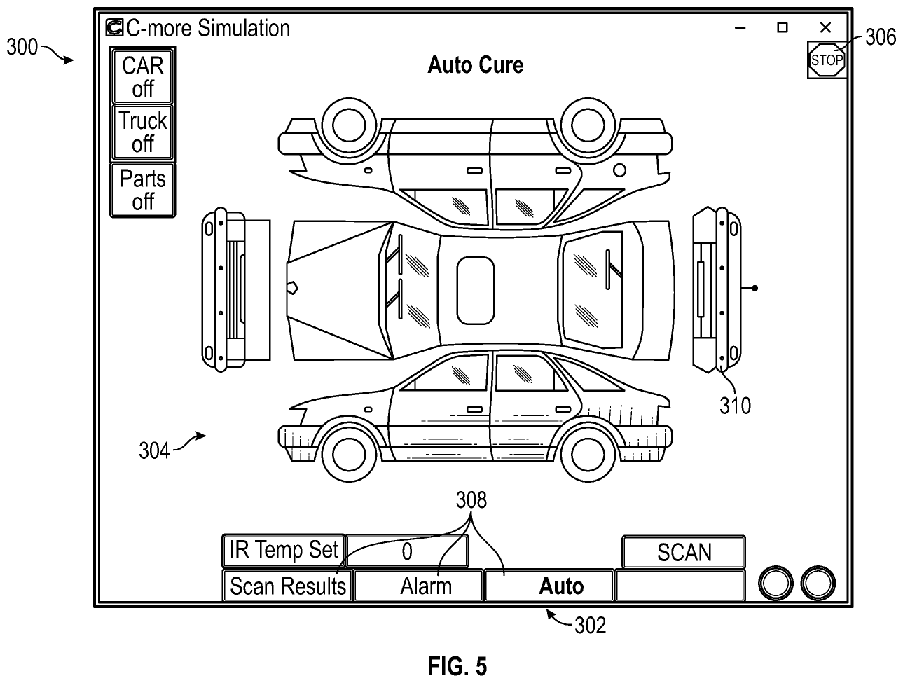

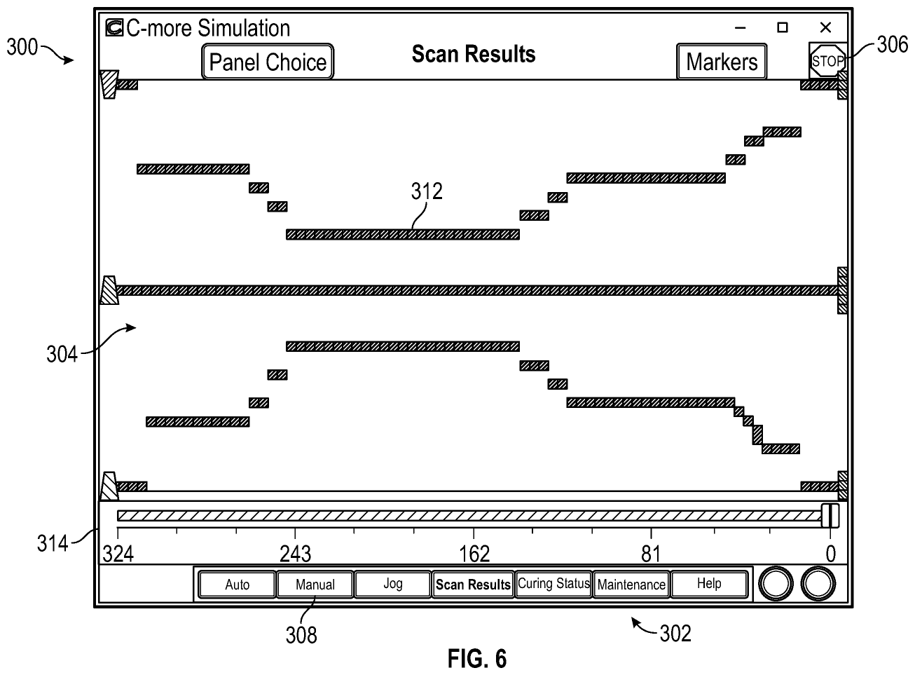

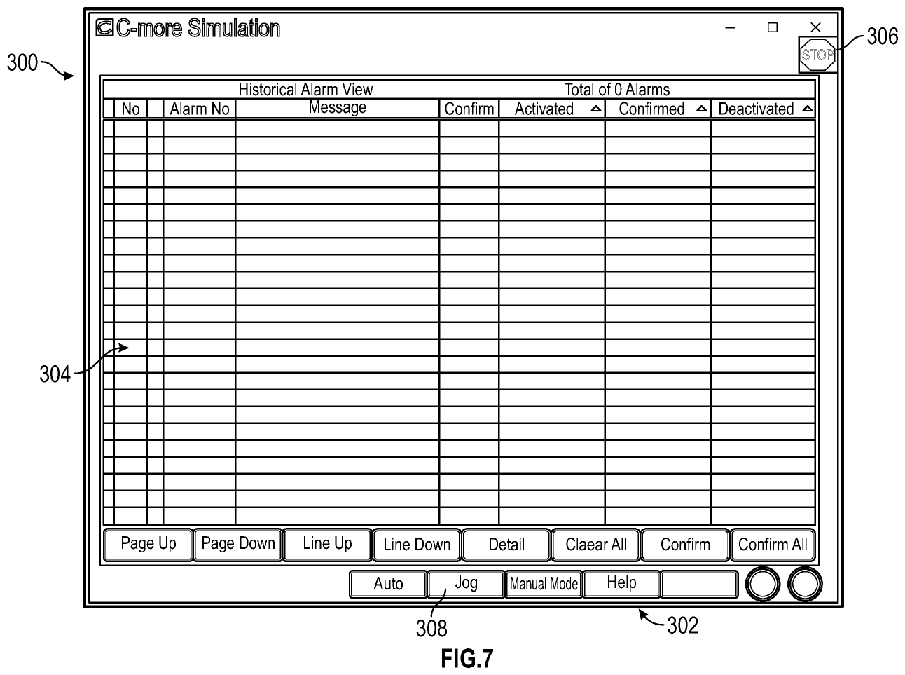

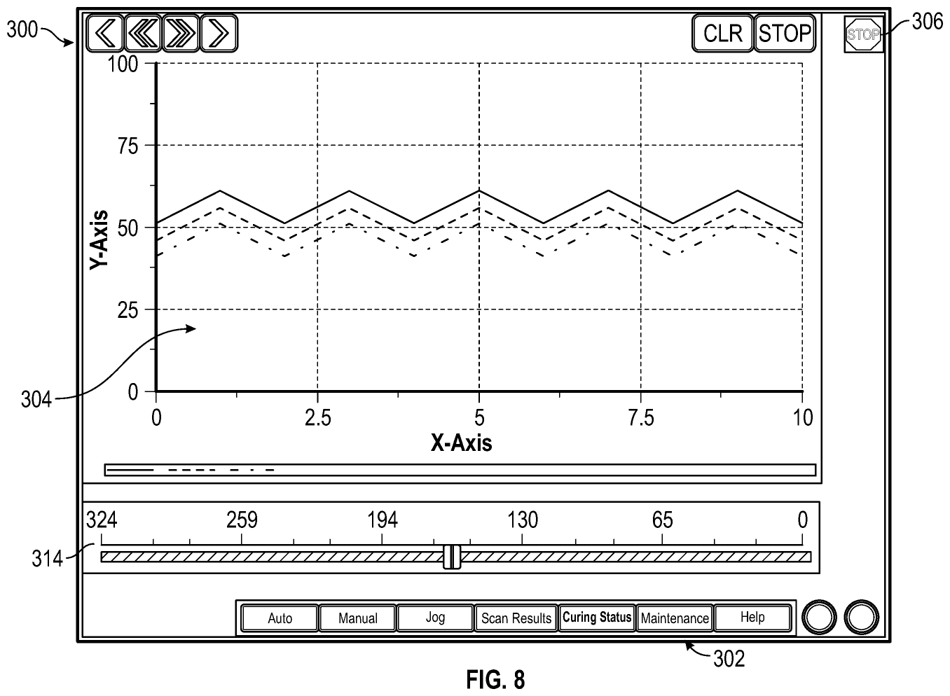

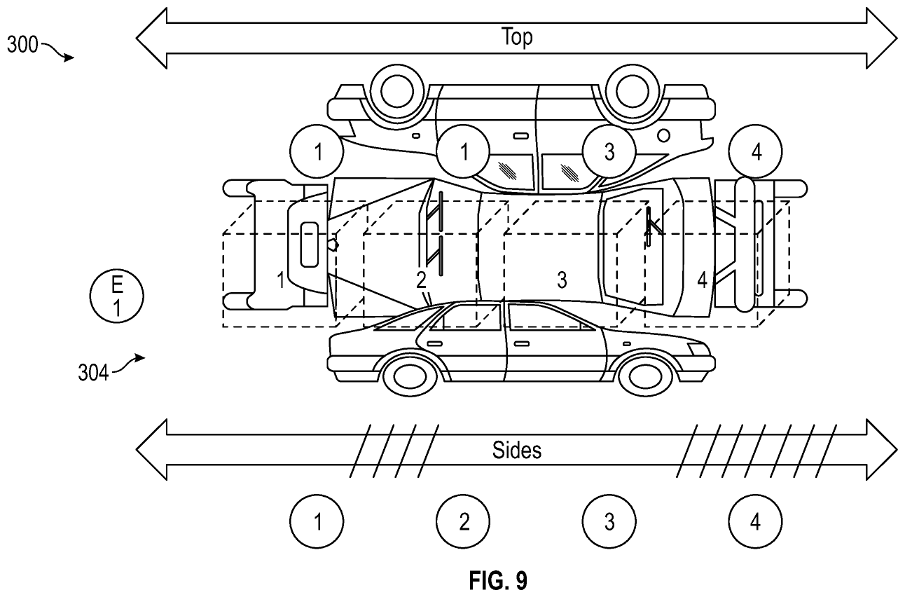

FIGS. 5-9 show embodiments of a graphical user interface (GUI) that includes display areas for displaying process input and output parameters. The GUI 300 can include a navigation pane 302, a display page (e.g., auto cure page, scan result page, alarm page, etc.) having a display area 304, and a stop button 306. A user can use the navigation pane 302 to navigate between display pages by clicking and/or pressing page indicators 308 corresponding to each display page (e.g., indicators labelled “Scan Results,” “Alarm,” and “Auto” in FIG. 5). The display pages can include, for example, an auto cure page (see FIG. 5) displaying a selected template for an object to be cured, a scan results page (see FIG. 6) displaying the results of a scan in the display area 304, a manual page allowing for manual input of process parameters (see FIG. 9), a curing status page (see FIG. 8) displaying the current status of the curing process, an alarm/alert page (see FIG. 7) displaying current and past alarms and alerts, a help page displaying troubleshooting information and/or instructions, and/or other various pages. In some embodiments, the navigation pane 302 can remain visible on all display pages.

Referring now to FIGS. 6 and 8, in some embodiments, the GUI can further comprise a distance tracking pane 314 that displays the current location of the curing system 100 along the tracks 122. In some embodiments, the distance tracking pane 314 can remain visible on all display pages.

As mentioned above, operation of the curing system 100 is controlled by control unit 110. The control unit 110 can receive and store one or more system inputs and can be configured to operate the curing system 100 based on those inputs. The system inputs can include, for example, a recipe, a template, and one or more system parameters. For example, the control unit 110 can be configured to: (a) receive and store recipe information, the recipe information comprising, for example, a selected temperature; (b) receive and store one or more system parameters including but not limited to the surface temperature of the object to be cured, the speed of the curing system, and the position of one of more curing elements relative to the object to be cured; (c) receive and store template data comprising a template of the object to be cured, and (d) adjust at least one of the speed of the movable housing, the temperature generated by the one or more curing elements, and the position of the curing elements relative to the surface of the object to be cured based on the received and stored system inputs.

The control unit 110 can be configured to operate in either a “manual” or an “automated” mode. In some embodiments, the control unit 110 can be configured to store previous operation parameters and/or recipes (either manual or automated recipes) to be logged and/or recalled for later use.

As used herein, the term “recipe” refers to a sequence or series of painting and/or curing steps, and/or other parameters associated with painting and/or curing a vehicle or other equipment, using the curing systems (or some portion thereof) disclosed herein. In automated mode, an operator can select a recipe, which can determine the optimum curing temperature and/or other process parameters. The recipe can comprise, for example, a selected operation (e.g., a ‘pre-heat’ operation, a ‘base coat’ operation, and/or a ‘clear coat’ operation) and a paint type (e.g., a paint brand). The control unit 110 determines a temperature to be used based on the operation and the paint type. Once the recipe has been selected, the operator can select a template corresponding to the general shape of the object to be cured. For example, in some embodiments, the templates include, but are not limited to: car, truck, van/sport utility vehicle (SUV), and/or miscellaneous parts. FIG. 5 shows an exemplary GUI wherein the template 310 selected is a car. If desired, the operator can select one or more individual parts to be cured, for example, by pressing on the parts in embodiments where the GUI is a touchscreen interface. In some embodiments, selecting an individual part for curing will highlight that part on the GUI display.

Once the template and/or individual parts have been selected, the curing system 100 can begin an automated scanning process. The scanning process uses the one or more sensors to determine the location of the object to be cured within the curing space 118. Based on the scan, the control unit 110 automatically selects one or more curing elements 108 to operate during the curing process. As shown in FIG. 6, the scan results can be displayed as a single profile outline of the scanned object 312. In other embodiments, the scan can be displayed as a 3D model. The control unit 110 determines a position for each curing element 108 based on the scan results and moves the curing elements 108 into the determined position. The control unit 110 also determines a start and stop location for the curing system 100 based on the scan results. The operator can then initiate the curing process using control unit 110.

As the curing process proceeds in automated mode, the curing system 100 automatically monitors the surface temperature of the object being cured using the one or more sensors. As the housing 102 advances over the object, the control unit 110 can automatically adjust the speed and distance of the housing 102 to maintain an optimum temperature as dictated by the recipe. In addition, if desired based on a predetermined recipe and/or information obtained from sensors during a curing operation, the curing system 100 can adjust the locations of the curing elements 108 relative to the object during the curing operation.

Manual mode is similar to automated mode, except that the operator can manually input one or more of the process parameters (e.g., temperature, speed, position of the curing elements) using an input device such as a touchscreen. As shown in FIG. 9, when in manual mode, the GUI can display a template divided into multiple zones. The operator can select a zone to undergo the curing process.

In addition to controlling curing system 100, control unit 110 can be configured to provide alerts and/or alarms. An alert, for example, can generate a warning and pauses the operation of the curing system 100. An alarm, for example, can generate a warning and/or disable the operation of the curing system. A warning can be, for example, a visual indicator, an audible indicator, or a tactile indicator such as a vibration. In some embodiments, if an alert is generated, operation of the curing system 100 continues and the alert is logged. In other embodiments, if an alert is generated, an operator can acknowledge the alert (e.g., by pressing and/or clicking on the alert) before operation of the curing system 100 resumes. In some embodiments, if an alarm is generated, operation of the curing system will be disabled until the error that created the alarm is fixed. In some embodiments, in cases where the error that generates the alarm is axis or drive related, the curing system 100 can be powered off and/or re-homed (e.g., returned to a starting ‘home’ position) in order to clear the alarm and allow the system to return to operation.

FIG. 7 shows an exemplary alarm/alert display. As shown, each alarm/alert can include an alarm number, which can be looked in a user manual to explain the basis of the alarm/alert. In some particular embodiments, the alerts can comprise a yellow indicator and the alarms can comprise a red indicator.

### GENERAL CONSIDERATIONS

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

All features described herein are independent of one another and, except where structurally impossible, can be used in combination with any other feature described herein.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A curing system, comprising:
a movable housing having a first side portion and a second side portion;
one or more curing elements coupled to the movable housing and movable relative to the movable housing, the one or more curing elements comprising first, second, and third curing elements each having a first end portion coupled to the movable housing and a second free end portion, the first end portions of the first and second curing elements being coupled adjacent to one another and the first end portion of the third curing element being coupled to the movable housing above the free end portion of the second curing element;
one or more sensors configured to scan an object to be cured;
a control unit operably coupled to the sensors and configured to generate a template based on the scan, the control unit further configured to adjust a speed of the movable housing and a temperature generated by the one or more curing elements based at least in part on the template such that a surface of the object to be cured reaches a selected temperature for a selected time period;
one or more tracks to which the movable housing is movably coupled, the movable housing further comprising one or more track sensors configured to monitor the motion of the movable housing along the tracks, wherein when the one or more track sensors pass a selected portion of the tracks the housing automatically enters a slow and park sequence; and
wherein the control unit positions the first, second, and third curing elements based on the template.

2. The curing system of claim 1, wherein the movable housing comprises a first shutter and a second shutter movable relative to the movable housing, wherein each shutter is coupled to at least one of the one or more curing elements, wherein the one or more curing elements are pivotable relative to the first and second shutters, and wherein the control unit positions the first and second shutters based on the template.

3. The curing system of claim 2, wherein the movable housing comprises a curtain coupled to and extending between the first and second side portions, wherein the curtain is movable along a first axis and rotatable about a second axis relative to the first and second side portions, wherein the curtain is coupled to at least a fourth curing element of the one or more curing elements, and wherein the control unit positions the curtain based on the template.

4. The curing system of claim 1, wherein the one or more sensors are additionally configured to measure a temperature of a surface of the object, and wherein each sensor is coupled to a respective forward rail and each sensor is configured to move along a length of the respective forward rail.

5. (canceled)

6. The curing system of claim 1, wherein the control unit is configured to receive and store recipe data, the recipe data comprising the selected temperature.

7. The curing system of claim 1, wherein the control unit is configured to receive and store recipe template data, the recipe template data comprising a template of the object to be cured not based on the scan.

8. The curing system of claim 7, wherein the control unit is configured to position the one or more curing elements based on at least one of the template and the recipe template data.

9. The curing system of claim 1, wherein the one or more curing elements comprise at least one of infrared (IR) elements and ultraviolet (UV) elements.

10. (canceled)

11. The curing system of claim 1, wherein the system is configured to operate within a National Fire Protection Association compliant painting booth.

12. The curing system of claim 1, further comprising one or more ambient sensors operatively connected to the control unit and configured to measure at least one of an ambient temperature and an ambient humidity, wherein the control unit is configured to automatically adjust at least one of the speed and temperature to compensate for environmental variations.

13. A curing system, comprising:
a movable housing having a first side portion and a second side portion movably coupled to one or more rails;
a curtain comprising one or more curing elements, the curtain coupled to and extending between the first and second side portions, the curtain being movable relative to the housing along a first axis and rotatable relative to the housing about a second axis;
one or more shutters each comprising one or more curing elements pivotably coupled to the shutters, the shutters being coupled to the housing and movable relative to the housing along a third axis, each curing element comprising a first end portion coupled to a respective shutter and a free end portion, each curing element being pivotable relative to the respective shutter about a pivot axis adjacent the first end portion;
one or more sensors configured to scan an object to be cured and generate a template;
a control unit configured to receive and store one or more system inputs including the generated template, the control unit configured operate the curing system in an automated mode;
one or more rail sensors configured to monitor the motion of the movable housing along the one or more rails, wherein when the one or more rail sensors pass a selected portion of the rails the housing automatically enters a slow and park sequence;
wherein when in the automated mode the control unit automatically adjusts at least one of a speed of the movable housing and a temperature generated by the one or more curing elements based at least in part on the template;
wherein the one or more curing elements of the shutters comprise first and second curing elements, the first end portions of the first and second curing elements being coupled to a first shutter of the one or more shutters at a location adjacent one another;
wherein the one or more curing elements of the shutters further comprise a third curing element, the first end portion of the third curing element being coupled to the first shutter at a location spaced apart from the first and second curing elements along the first axis;
wherein the one or more curing elements of the curtain comprise a fourth curing element and
wherein the control unit selects one or more of the first, second, third, and fourth curing elements to operate during the process based on the generated template.

14. The curing system of claim 13, wherein the one or more system inputs additionally include a recipe comprising a selected temperature.

15. The curing system of claim 13, wherein the control unit automatically adjusts at least one of the speed of the movable housing and the temperature generated by the one or more curing elements based at least in part on the template such that a surface of an object to be cured reaches a selected temperature for a selected time period.

16. The curing system of claim 13, wherein the one or more system inputs include a recipe comprising a recipe template of the object to be cured.

17. The curing system of claim 16, wherein the control unit is configured to position the one or more curing elements based on at least one of the recipe template and the generated template.

18. The curing system of claim 13, wherein the one or more system inputs further comprise at least one of a surface temperature of the object to be cured, a position of the one or more curing elements relative to a surface of the object to be cured, and a speed of the curing system.

19. The curing system of claim 13, wherein the one or more system inputs include at least one of an ambient temperature and an ambient humidity, and wherein the control unit is configured to automatically adjust at least one of the speed and temperature of the curing elements to compensate for environmental variations.

20. A curing system, comprising:
a movable housing;
a curtain coupled to the movable housing, the curtain comprising one or more curing elements and being movable relative to the housing along a first axis and rotatable relative to the housing about a second axis;
one or more shutters each comprising one or more curing elements pivotably coupled to the shutters, the shutters being coupled to the movable housing and being movable relative to the housing along a third axis, each shutter comprising first, second, and third curing elements, the first and second curing elements being pivotable relative to the respective shutter and comprising first end portions coupled to the respective shutter at locations adjacent one another, the third curing element being pivotable relative to the respective shutter and comprising a first end portion coupled to the respective shutter at a location adjacent a second end portion of the second curing element;
one or more sensors coupled to the movable housing and movable relative to the housing along the first axis, the sensors configured to determine an outer profile of an object to be cured;
one or more tracks along which the movable housing can move, the movable housing further comprising one or more track sensors configured to monitor the motion of the movable housing along the tracks, wherein when the one or more track sensors pass a selected portion of the tracks the movable housing automatically enters a slow and park sequence;
a display; and
a control unit operatively coupled to the display, the control unit configured to: (a) receive and store recipe information, the recipe information comprising a selected temperature, (b) receive and store one or more system parameters, the one or more system parameters comprising: a surface temperature of an object to be cured, a position of the one or more curing elements relative to a surface of the object to be cured, and a speed of the movable housing, (c) receive and store template data comprising the outer profile of the object to be cured and generate a template based on the outer profile, (d) adjust at least one of: the speed of the movable housing and the temperature generated by the one or more curing elements, based on the recipe and the one or more system parameters, (e) position the curing elements relative to the surface of the object to be cured based on the template data, and (f) display the generated template on the display.

21. The curing system of claim 20, wherein the control unit is further configured to generate one or more alerts configured to identify selected malfunctions during a curing process.

22. The curing system of claim 1, wherein the object to be cured is a component of a vehicle separate from the vehicle.
